(19) United States
(12) Patent Application Publication
(10) Pub. No.: US 2013/0029019 A1
(43) Pub. Date: Jan. 31, 2013

(54) ICE POP MAKER WIITH REMOVABLE MOLD INSERT AND METHOD FOR USING THE SAME

(71) Applicants: Ernest B. Pryor, JR., Maidens, VA (US); Michael G. Sandford, Chester, VA (US); Paul M. Blankenship, Glen Allen, VA (US)

(72) Inventors: Ernest B. Pryor, JR., Maidens, VA (US); Michael G. Sandford, Chester, VA (US); Paul M. Blankenship, Glen Allen, VA (US)

(21) Appl. No.: 13/362,079

(22) Filed: Jan. 31, 2012

Related U.S. Application Data
(60) Provisional application No. 61/443,006, filed on Feb. 15, 2011.

(51) Int. Cl. A23G 9/26; A23P 1/10

(52) U.S. Cl. 426/389; 99/485

(57) ABSTRACT

An ice pop making apparatus for rapid or “on demand” ice pop production involves an apparatus and method whereby one or more mold inserts are removable from the ice pop making apparatus subsequent to an edible product being frozen in the mold insert. The mold insert is exposed to ambient conditions or a fluid bath or stream to release the edible material from the mold insert. The mold insert may be cleaned and/or filled remotely from the ice pop making apparatus so that the ice pop making apparatus will be kept clean and there is no cross-contamination of edible products or flavors between consecutive batches of ice pops.

This application claims the benefit of U.S. Provisional Application No. 61/443,006, filed Feb. 15, 2011.

### SUMMARY

The present disclosure is directed to an ice pop making apparatus. More particularly, the disclosure relates to an apparatus to facilitate and speed the freezing of an edible material on a stick via a refrigerant media. The apparatus and method also comprises the subsequent removal of one or more mold inserts containing the frozen edible material from the apparatus. The independent, selectively removable mold insert permits the ready removal of the frozen edible material from the apparatus thereby simplifying operation of the apparatus and providing a sanitary and easy-to-clean unit. The mold insert can then be exposed to ambient conditions or a fluid bath or stream to release the edible material from the mold insert.

### BACKGROUND

Ice cream and ice pops are commercially-made, frozen confections. There has been an on-going interest in producing home-made ice cream. However, there have been very few products to effectively produce ice pops in the home in an expedited manner. Conventional ice pop makers require a user to leave a fluid drink or mixture in a freezer for an extended period of time. These conventional ice pop makers do not provide instantaneous or near instantaneous gratification. It can take hours for the desired product to freeze into the desired ice pop. In other words, they are not “on demand” or quick ice pop makers.

There are a number of technical challenges to providing ice pops in mere minutes that have yet to be effectively solved. For instance, even where known equipment can quickly produce an ice pop, it can be very difficult to remove the ice pop from the ice pop-making apparatus. In fact, one item of conventional wisdom is that an extraction tool is needed in order to get the frozen material out of the ice pop making apparatus.

Known devices could also be more sanitary and easier to clean. Currently, the edible product that is to be frozen in a quick freeze ice pop maker is placed directly into the apparatus. Residue of the ice pop remains in the apparatus even after the ice pop is removed for consumption. As such, it is necessary to clean the apparatus after each use if the user does not wish to contaminate a second batch of ice pops with the residue of an earlier batch. However, cleaning and washing the apparatus raises the temperature of the apparatus so that the ice pop maker is not, at least temporarily, suitable for its intended purpose. The ice pop maker would have to be returned to a freezer for an extended period thereby defeating the “on demand” operation expected in a quick pop maker. In other words, there is at least a need for an apparatus that has the ability to make consecutive batches of uncontaminated ice pops in an expedited manner. An ice pop maker that would allow an ice pop to be removed in the absence of an extraction tool or release coating would also be desired.

An ice pop maker in accordance with the following disclosure addresses these and/or other shortcomings of conventional quick ice pop makers and otherwise overcomes the disadvantages presented by existing technologies.

### SUMMARY

The present disclosure is directed to an ice pop maker and method of operating the same wherein a selectively removable ice pop mold insert is employed. For the purposes of this disclosure, an ice pop is a frozen comestible on a stick. The subject ice pop maker makes it surprisingly easy to remove the ice pop from the ice pop maker. A hidden release mechanism may also be employed to facilitate the release of an ice pop mold insert from the ice pop maker apparatus.

The ice pop maker, in accordance with one embodiment of the disclosure, comprises an outer shell, an inner sleeve, refrigerant media, an ice pop stick, a combination stick holder and fluid funnel, and a selectively removable ice pop mold insert. The refrigerant media is stored between the outer shell and inner sleeve. The refrigerant media would typically be some product that freezes below 32 degrees Fahrenheit, such as salt water, propylene glycol, ammonia solution, or the like, although many other fluids could be employed. The refrigerant solution stores sufficient energy to freeze a fluid product placed in the ice pop maker via the mold insert within a matter of minutes. The refrigerant solution is cooled by storing the apparatus in a refrigerated space, such as a freezer, for a period of time.

In one embodiment, the inner sleeve may employ cooling fins that extend from the inner sleeve into the refrigerant media as a heat exchanger. The increased surface area aids the energy transfer between the refrigerant media to the inner sleeve, as further explained below. In at least one of the embodiments, the inner sleeve has one or more apertures extending all the way therethrough. The removable mold insert can be supported in each of the apertures.

The independent, selectively removable ice pop mold insert is sized to fit and nest within the inner sleeve so that the outer walls of the mold insert are in close contact with the walls forming the apertures through the inner sleeve. The ice pop stick is placed in the mold insert and can be held in place by the combination ice pop stick holder and fluid funnel. The mold insert is filled with an edible liquid product either before or after the mold insert is placed in the inner sleeve of the ice pop maker.

The refrigerant media creates a thermal transfer through the inner sleeve and mold insert. When the refrigerant media is properly conditioned, the contents of the mold insert freeze on the ice pop stick in a matter of minutes. Depending on many variables including the starting temperature of the fluid in the mold insert, the storage temperature and length of time the ice pop maker was chilled, and the like, the mold insert contents will generally freeze in about 7 to 15 minutes. Generally, the comestible fluid or mixture freezes in 10 minutes or less. The ice pop (i.e., the frozen material and the stick) is then removed from the mold insert in order to consume the frozen comestible product.

If the product is sufficiently frozen, the ice pop will not automatically separate from the mold insert. Instead, the user can grasp the mold insert to pull the insert with the ice pop in it from the ice pop maker. It is possible that the mold insert can be frozen or bonded to the sleeve or otherwise hard to grasp. A hidden release mechanism, as discussed further below, can be employed to cause a relative motion between the ice pop maker inner sleeve and the mold insert. The relative motion force is sufficient to release the mold insert from the inner sleeve and to extend a portion of the mold insert above the inner sleeve so that the user can grasp and easily remove the mold insert via the ice pop stick or by grasping and pulling the mold insert.

Once the mold insert is removed from the apparatus, the ice pop can be released from the mold insert by subjecting the mold insert to ambient air conditions or, more efficiently, by exposing the exterior surface of the mold insert to a fluid bath or stream. This releases the bond between the ice pop and the inner surface of the mold insert so that the ice pop is easily extracted from the mold insert by hand. A user simply grasps the ice pop stick and retracts it from the mold insert. No extraction tool is needed to remove the ice pop from the mold insert, which simplifies the method of operating the apparatus and lowers costs. A release coating on the mold insert is also not needed, further lowering costs. The composition, texture, etc. of the interior surface of the mold insert is not critical as the temperature differential between the inner surface and outer surface can be used to release the ice pop.

The construction and operation of the subject quick pop maker eliminates any concerns about the ice pop sticking, breaking, or otherwise being damaged in the quick pop maker when trying to remove it via an extraction tool. The subject construction provides a simpler, more cost effective solution to the known problem of removing an ice pop from a quick ice pop maker.

The construction of the inner sleeve, which has an aperture entirely therethrough (i.e., open at both ends), requires two seals with the outer shell. The first seal is located proximate the top end of the ice pop maker. A second seal adjacent the lower edges or bottom end of outer shell and inner sleeve to contain the refrigerant media inside the cavity formed by the inner sleeve and outer shell. Manufacturing tolerances require the careful arrangement and selection of seals. In one embodiment, a flat seal is employed at the top end and a radial seal is used adjacent the connection at the bottom end.

An additional problem is presented by maximizing the surface-to-surface contact between the inner sleeve and mold insert. Any gap between the two surfaces acts as an insulator or decreases thermal conductivity between the two parts. Maximum surface contact is desired for heat transfer purposes. In one embodiment, the inner sleeve is to a final shape and the mold insert is created via spin forming and then lathe finished to a final shape. Tolerances between the two parts can be problematic, but deep drawing or other manufacturing methods could be employed.

As briefly noted above, a hidden release mechanism for the mold insert can be employed. To accomplish one embodiment of the release mechanism, the housing and an inner sleeve are supported upon a base but are spaced apart from the base via post-supported springs. The springs bias the inner sleeve and outer shell away from the base. Downward force on the outer shell or inner sleeve overcomes the spring bias. The inner sleeve and outer shell have a downward range of motion towards the apparatus' base. The mold insert, however, is supported on an upward projecting member of the base or otherwise have a more limited range of downward motion. The upward projecting members are axially aligned with the aperture in the inner sleeve and limit the downward motion of the mold insert. In other words, the upward projecting members act as a “stop” and do allow the mold insert to move downwards to the same extent that the inner shell can move.

Since the mold insert has a more limited range of motion, or none at all, the downward force on the outer shell causes relative movement between the inner sleeve and the mold insert. As a result, surface tension or bonding between the mold insert and inner sleeve that might impede the removal of the mold insert from the inner sleeve is overcome. A portion of the mold insert is also exposed. A user can then easily remove the mold insert from the ice pop maker apparatus by pulling the ice pop stick or directly grasping and retracting the mold insert.

An ice pop maker in accordance with the present disclosure is easy to operate and clean and is relatively inexpensive to make and own. The ice pop maker does not require an extraction tool or any specialized release coatings. Moreover, the maker is more sanitary than known ice pop makers in that the portion of the apparatus that contacts the edible material (i.e., the mold insert) is independently removable. Any remnants of the edible material can easily be cleaned from the mold insert without having to wash the inner sleeve or outer shell that house the refrigerant media. As such, cleaning the mold inserts does not dissipate the energy stored in the refrigerant solution as it would if one were required to wash the reside directly off the apparatus itself. Overall, the subject ice pop maker is relatively easy to clean, is more sanitary, is easier to operate, and should cost less to manufacture than known ice pop makers.

Further features and advantages of the present invention will become apparent to those of skill in the art from the following detailed description of a preferred embodiment taken in conjunction with the accompanying drawings.

### BRIEF DESCRIPTION OF THE DRAWINGS

FIG. 1 depicts one embodiment of the subject ice pop making apparatus with removable mold insert as disclosed herein;

FIG. 2 is a top view thereof;

FIG. 3 is an exploded view thereof;

FIG. 4 is an exploded, side, cross-sectional view thereof;

FIG. 5A is a cross-sectional view from one end of the apparatus as disclosed herein;

FIG. 5B is an additional cross-section side view thereof;

FIG. 6 is a close up cross-sectional view thereof; and

FIG. 7 is a perspective view from the bottom and one end of the subject apparatus as disclosed herein.

### DETAILED DESCRIPTION

The present disclosure is directed to an ice pop maker and the method of using the same. The ice pop maker is described in terms of various embodiments disclosed and illustrated herein. The subject ice pop maker comprises a novel construction and method of operation. The ice pop maker includes various components including a selectively removable ice pop mold insert that provides for a more sanitary apparatus with easier operation than known devices. A release mechanism can facilitate the removal of the mold insert. The subject apparatus will freeze a comestible fluid or mixture in a very short period of time, typically in 10 minutes or less. Of course, the present invention is not limited to the specific embodiments as follows but also includes variations and equivalent structures that would be apparent to one of skill in the art upon review of the disclosure as a whole.

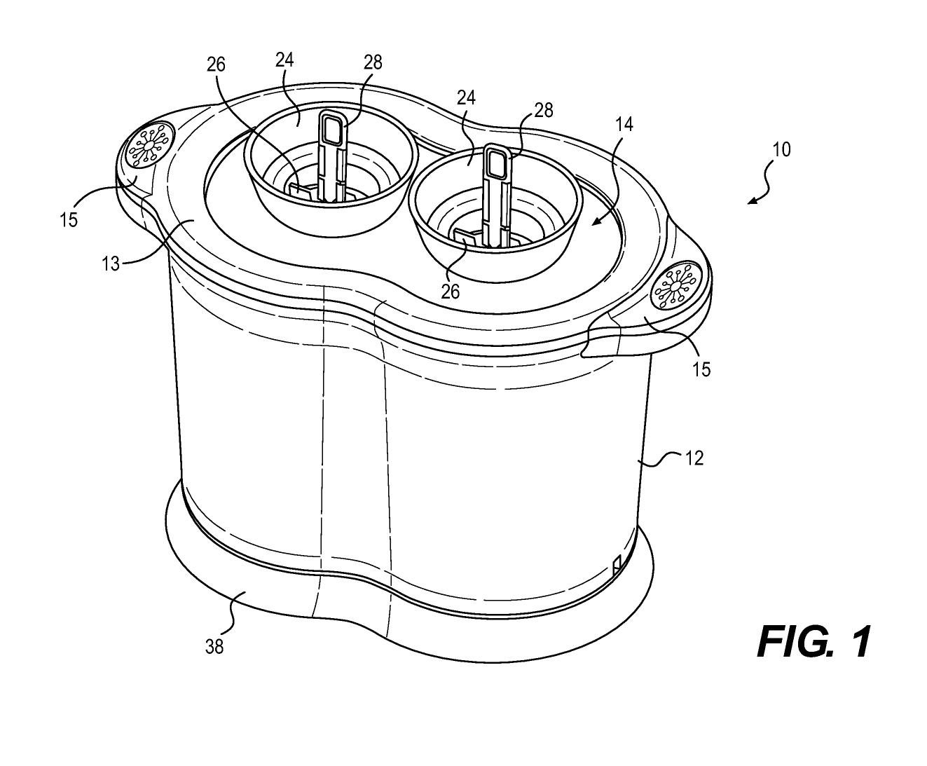

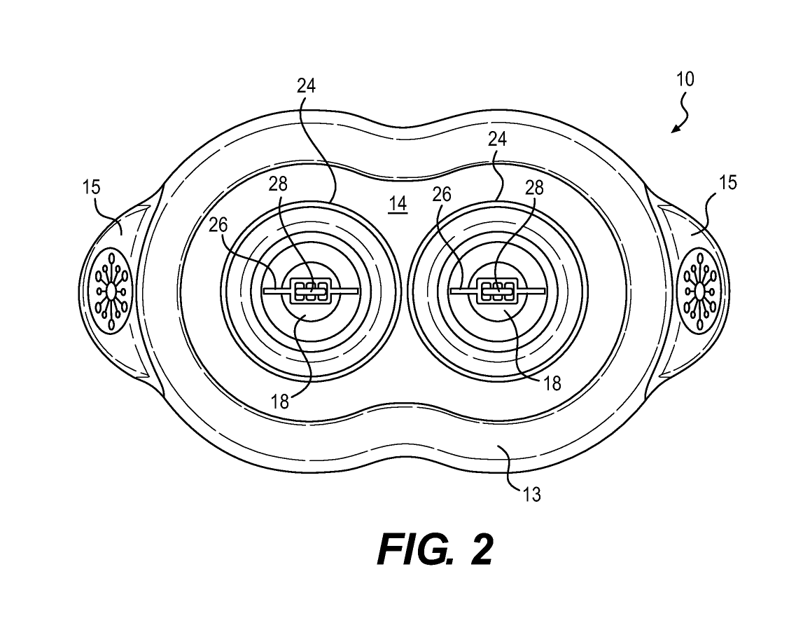

As illustrated herein, and with specific reference to FIGS. 1 and 2, the quick pop making apparatus 10 comprises, in at least one embodiment, an outer shell 12 and an inner sleeve 14 that are joined together to create a sealed cavity therebetween. A refrigerant media (not illustrated) is stored between outer shell 12 and inner sleeve 14 in the cavity. The refrigerant media would typically be some product that freezes below 32 degrees Fahrenheit, such as salt water, propylene glycol, ammonia solution, or the like, although many other fluids could be employed. Ice pop maker 10 is stored in a freezer for a period of time to lower the temperature of the refrigerant media. This thermal energy is stored in the refrigerant media for a period of time when ice pop maker 10 is removed from the freezer.

Outer shell 12 can be plastic, metal, or any suitable fluid-tight material. Outer shell 12 forms the outer and lower walls of the refrigerant media cavity. For cost savings and to prevent energy loss of the refrigerant media though outer shell 12, a plastic shell is preferred but not required. A bezel 13 is snap-fit or otherwise secured to the upper edge of shell 12. Bezel 13 can be formed from plastic or other suitable material, although it is thought a material with low thermal conductivity is preferred so as to protect a user from a cold surface. To that end, bezel 13 can further include handles 15 to facilitate handling and operation of ice pop maker 10.

Outer shell 12 is fastened to inner sleeve 14 by screws or other known fasteners or fastening mechanism. Inner sleeve 14 forms the upper wall of the refrigerant media cavity as well as at least one passageway therethrough.

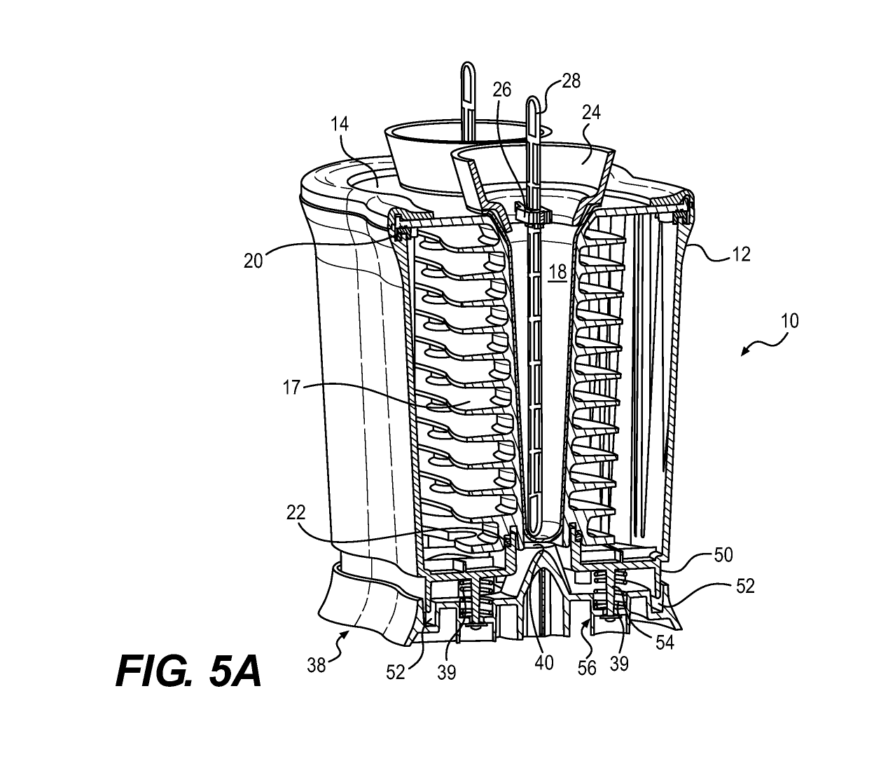

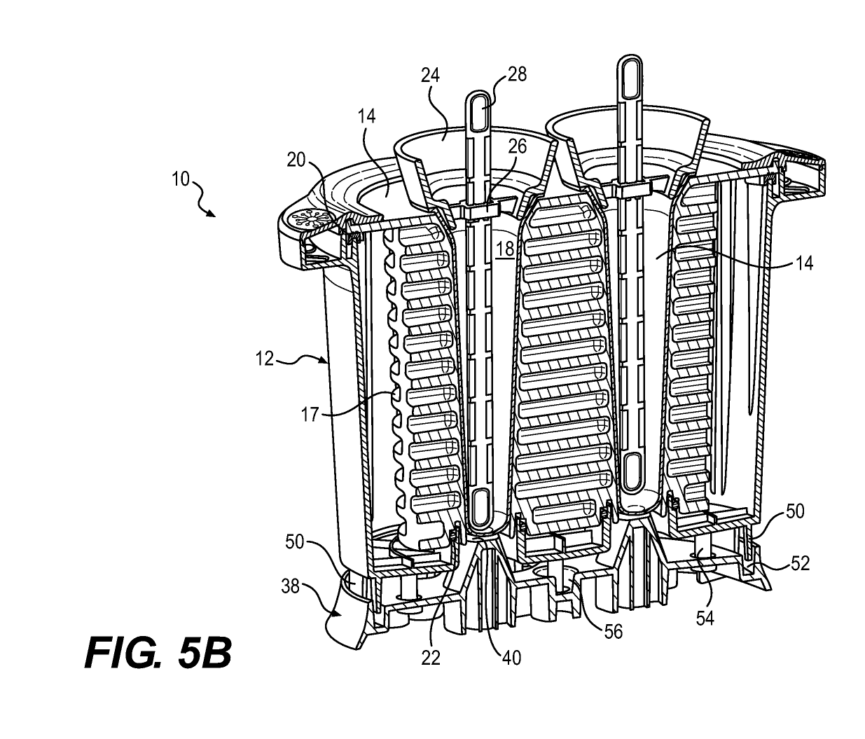

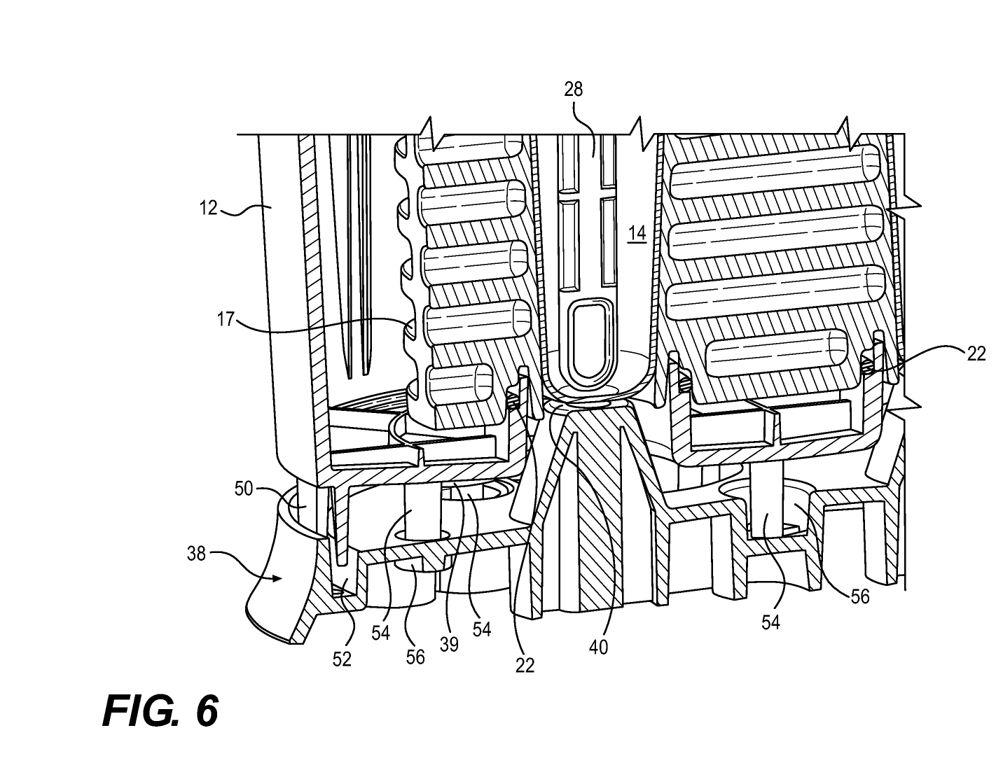

For reasons elaborated on below, inner sleeve 14 is preferably a material with a relatively high rate of thermal conductivity, such as a metal. A plurality of cooling fins 17 (see, in particular, FIG. 5A-6) extends from inner sleeve 14 into the refrigerant media cavity created by inner sleeve 14 and outer shell 12. Cooling fins 17 also exhibit a high rate of thermal conductivity and are submerged in the refrigerant media. Fins 17 provide a greater surface area of contact between inner sleeve 14 and the refrigerant media.

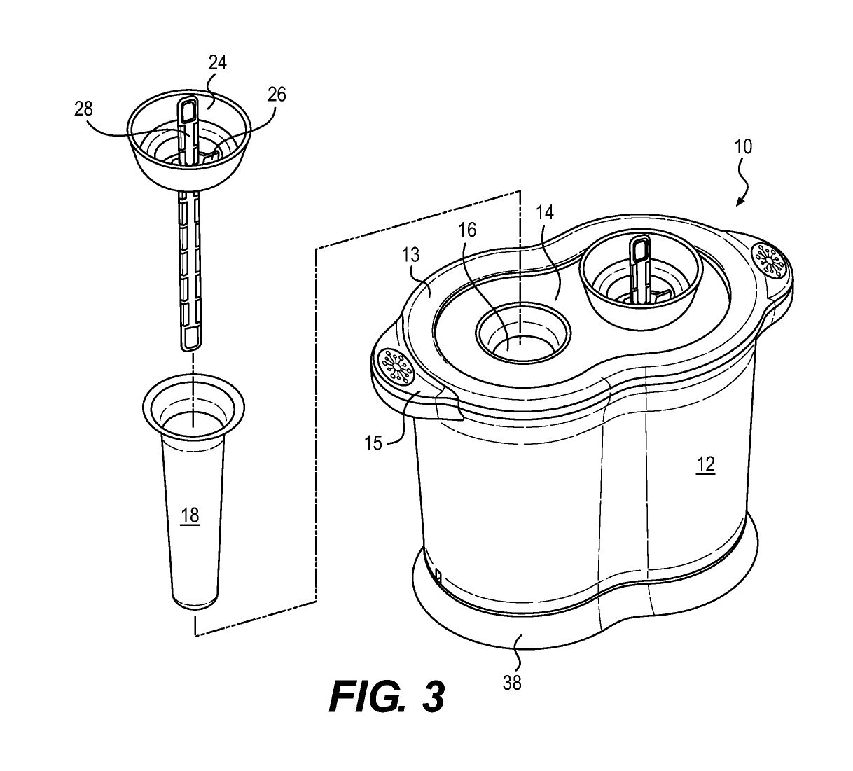

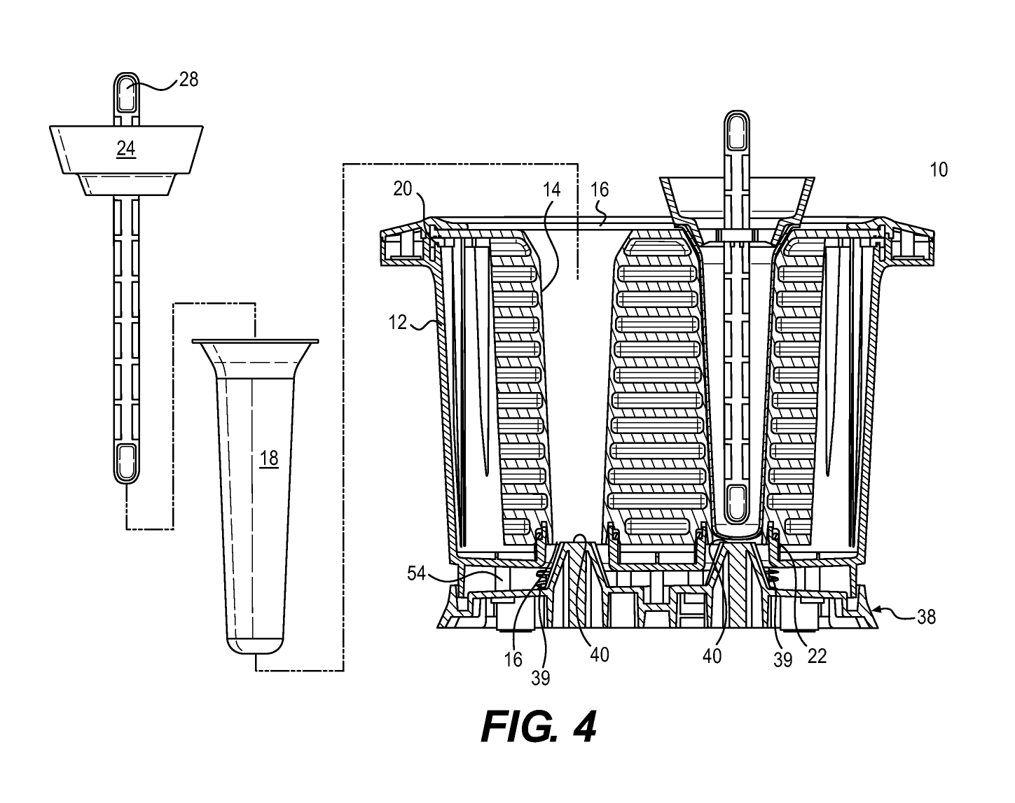

Referencing also FIGS. 3 and 4, and as briefly noted above, inner sleeve 14 comprises at least one aperture 16 extending therethrough from an upper end of inner sleeve 14 to a bottom end of inner sleeve 14. The upper end of aperture 16 is chamfered outwardly. Sleeve 14 may be mechanically stamped, deep-drawn, die-cast or produced by other suitable means. A die-cast aluminum construction is preferred but not required.

An independent and selectively removable mold insert 18 can be inserted into inner sleeve 14 via aperture 16. Mold insert 18 is sized to nest within inner sleeve 14 and includes a first open end and a second closed end. While mold insert 18 is illustrated herein as having a circular cross section and a tapered body from the open end to the closed end, which corresponds to the shape of aperture 16, the specific shapes of aperture 16 and mold insert 18 are not critical. For the most efficient operation of ice pop maker 10, the outer dimensions of mold insert 18 should closely conform to the dimensions of aperture 16 so as to maximize the surface contact between the two. Mold insert 18 can rest on the chamfered portion of aperture 16 (i.e., it is suspended within aperture 16) or stand on or be supported by an optional base projection 40 adjacent the lower end of aperture 16.

An upper seal 20 is placed between inner sleeve 14 and outer shell 12 to hold the two components together more securely and to prevent the escape of any refrigerant media from the cavity. Upper seal 20 can be a known gasket or seal, such as a flat seal. Aperture 16 through inner sleeve 14 requires there be an additional seal at the lower end of inner sleeve 14. It has been found that a radial seal 22 effectively joins the bottom end of inner sleeve 14 to outer shell 12 and also prevents the escape of the refrigerant media from the cavity created by outer shell 12 and inner sleeve 14. Other types of seals or gaskets may be suitable for lower seal 22.

Mold insert 18 can be filled with an edible liquid material before or after being inserted into aperture 16 of inner sleeve 14. A funnel 24 can nest in the upper opening of mold insert 18 to guide a fluid into mold insert 18. Funnel 24 includes an opening therethrough and a tapered cross-sectional shape. A bridge 26 extends across the funnel opening and includes a stick opening. An ice pop stick 28 is supported in the stick opening to retain stick 28 in position in mold insert 18. The stick opening can accommodate molded plastic sticks, conventional wooden ice pop sticks (i.e., Popsicle™ sticks), and the like.

The chilled refrigerant media extracts thermal energy from the fluid or mixture in mold insert 18 through inner sleeve 14 and mold insert 18. The media has enough stored energy to freeze the fluid or mixture on stick 28 to form an ice pop. Mold insert 18 may be plastic, metal or other viable material. A metal mold insert 18 is thought to effectively allow the rapid transfer of thermal energy between the refrigerant media and the interior of the removable mold insert 18. In addition, in the event mold insert 18 is removed from the apparatus while containing an ice pop, exposing a metal mold insert 18 to a warm environment (e.g., running tap water, warm air, or the like) will quickly cause the frozen material in mold insert 18 to loosen from mold insert 18 due to the effective heat transfer provided by metal and, in part, due to the expansion and contraction of the metal. In any event, no extraction tool is required to remove the resulting ice pop. A release coating is also not needed. The independent, selectively removable mold insert 18 provides for the easy operation of ice pop maker 10, easy cleaning of the same, and facilitates the removal of the ice pop from ice pop maker 10.

By this removable mold insert construction, the liquid or material used to create the ice pop does not touch inner sleeve 14. Consequently, inner sleeve 14 is not contaminated with foodstuff at any point. In fact, inner sleeve 14 cannot independently retain any fluid introduced via aperture 16 as inner aperture 16 is open on both ends of inner sleeve 14. In other words, inner sleeve 14 cannot act as a reservoir.

Stick 28 is envisioned as a one-piece, injection-molded plastic stick, which would be reusable and machine washable. Funnel 24 can be independent of stick 28 so that it is operable with a variety of different stick types including traditional, wooden ice pop sticks. Funnel 24 could alternatively be a molded collar proximate to and integral with one end of stick 28.

Overall, the removal of the ice pop from ice pop maker 10 is facilitated by the use of a removable mold insert 18. While the thermal exchange between the refrigerant media and fluid or mixture to be frozen occurs through two intervening layers (i.e., the wall of inner sleeve 14 and mold insert 18), it was surprisingly found that the rapid freezing of the edible product could be achieved. Removing the ice pop and mold insert 18 from ice pop maker 10 aided the cleaning of the ice pop making apparatus 10 and made it possible to produce consecutive batches of ice pops without any cross-contamination issues.

A removable mold insert, as disclosed herein, produces a method of using the subject apparatus that is unique to quick ice pop makers. To operate the ice pop maker 10, a user would place ice pop maker in a freezer for an amount of time sufficient to chill and condition the refrigerant solution. The apparatus is removed from the freezer. Ice pop mold insert 18, with or without any contents, is placed in the upper end of aperture 16 of inner sleeve 14. The combination funnel and stick holder 24 and ice pop stick 28 are placed in ice pop mold insert 18. Unless already completed, a fluid or mixture is added to ice pop mold insert 18. Advantageously, the fluid can be added to mold insert 18 prior to mold insert 18 being placed in quick pop maker 10 so that any spills do not contaminate or freeze to ice pop maker 10.

In a period of minutes, the fluid or mixture in mold insert 18 will be frozen to stick 28. A user can grasp mold insert 18 and remove mold insert 18 from ice pop maker 10. The exposure to ambient air conditions or a bath or stream of fluid will release the ice pop from mold insert 18. If a second or subsequent ice pops are desired, a user can clean mold insert 18, dry it off, and reinsert mold insert 18 for further use. Cross contamination between ice pop batches is prevented and it is not necessary or suggested to clean outer shell 12 or inner sleeve 14 between batches, which would dissipate the energy stored in the refrigerant media.

It is possible for mold insert 18 to create sufficient surface bonding or otherwise freeze to inner sleeve 14 such that an optional mold insert release mechanism might be employed. In one embodiment, the mold insert release mechanism comprises a relative motion system between inner sleeve 14 and mold insert 18.

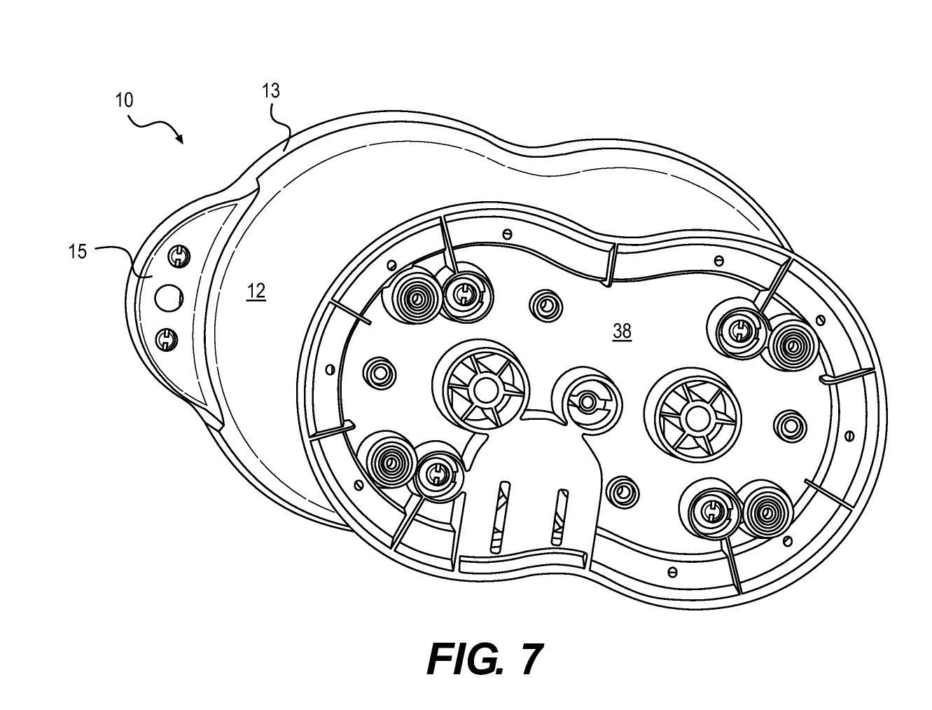

In further detail, and with reference to the figures, including FIGS. 4-7, outer shell 12 and inner sleeve 14 are supported upon a base 38 but spaced apart from base 38 via post-supported springs 39. Springs 39 bias inner sleeve 14 and outer shell 12 away from base 38. Downward force on outer shell 12 or inner sleeve 14 overcomes the spring bias thereby allowing inner sleeve 14 and outer shell 12 a range of downward motion. Mold insert 18, however, is either suspended in aperture 16 of sleeve 14 or is supported by base 38 in a manner that does not permit the same, or any, range of downward motion. Therefore, the downward movement of outer shell 12 and inner sleeve 14 causes relative movement between inner sleeve 14 and mold insert 18. As a result, surface tension, bonding or any other binding force that might impede the removal of mold insert 18 from inner sleeve 14 is overcome. In addition, the downward movement of inner sleeve 14 relative to mold insert 18 can physically present or expose mold insert 18 above the top wall of inner sleeve 14 so that mold insert 18 can be more easily grasped by a user. The user then easily removes mold insert 18 from ice pop maker 10. The ice pop is released from mold insert 18 in the manner described above.

In still further detail, as perhaps best illustrated in the close-up, sectional illustration of FIG. 6, outer shell 12 includes a circumferential lower lip 50 that fits within a groove 52 provided by base 38. A plurality of posts 54 extend down from the bottom side of outer shell 12. Posts 54 are received by pockets 56 of base 38 and extend through apertures in the pockets. Fasteners are attached to the distal end of posts 54. The fasteners do not fit through the pocket openings so that outer shell 12 and inner sleeve 14 are secured to base 38. Posts 54 can move down through the pocket apertures. However, posts 54 are naturally biased to the uppermost position by the bias force of springs 39 on outer shell 12. The post fasteners limit the upward range of motion.

Springs 39 can comprise coil or other suitable types of springs that are situated around some or all of posts 54. Springs 39 bias shell 12 and sleeve 14 away from base 38. As a result, the fasteners are brought into contact with base 38. In this position, lip 50 is positioned in groove 52 but there is downward range of motion. A user pushes down on outer shell 12 or inner sleeve 14. The spring bias is defeated and posts 54 move down through the pocket apertures. Lip 50 also moves down within groove 52 until it abuts base 38.

Base 38 further includes upwardly extending base projections 40 that limit the downward motion of mold insert 18 relative to inner sleeve 14. Mold insert 18 is either in contact with projections 40 at all times or are suspended in aperture 16 just above base projections 40. Therefore, mold inserts 18 have little to no downward range of motion and specifically less of a downward range of motion relative to the base than do the outer shell 12 and/or inner sleeve 14. Therefore, pushing down on outer shell 12 ‘releases’ mold insert 18 from inner sleeve 14. A user grasps and removes mold insert 18 from ice pop maker 10.

While the present disclosure has been described with reference to specific embodiments thereof, it will be understood that numerous variations, modifications and additional embodiments are possible, and all such variations, modifications, and embodiments are to be regarded as being within the spirit and scope of the invention.

What I claim is:

1. An ice pop maker comprising:
an inner sleeve, the inner sleeve including at least one aperture therethrough, the at least one aperture including a first, upper open end and a second, lower open end;
an outer shell, the outer shell connected to the inner sleeve and forming a sealed cavity therebetween;
a refrigerant media contained within the cavity;
a removable mold insert sized and configured for selective placement in the at least one aperture of the inner sleeve;
a stick holder and a stick positioned at least partially inside the mold insert; and
an edible product located in the mold insert, the edible product frozen by the ice pop maker to form an ice pop.

2. The ice pop maker of claim 1 with the proviso that the ice pop maker does not include a removal tool to extract the frozen ice pop from the ice pop maker.

3. The ice pop maker of claim 1 with the proviso that the ice pop maker does not comprise a release coating.

4. The ice pop maker of claim 1, the inner sleeve further comprising cooling fins that extend from the inner sleeve into the refrigerant media as a heat exchanger.

5. The ice pop maker of claim 1, further comprising a release mechanism operable to release the mold insert from the inner sleeve.

6. The ice pop maker of claim 4, the release mechanism further comprising a relative motion mechanism that moves the inner sleeve relative to the mold insert and the relative motion being sufficient to release the mold insert from the inner sleeve and to extend a portion of the mold insert from the inner sleeve.

7. The ice pop maker of claim 1, further comprising a first seal proximate a top end of the ice pop maker and a second seal adjacent a bottom end of the inner sleeve and outer shell, the first and second seals sealing the cavity formed by the inner sleeve and outer shell.

8. The ice pop maker of claim 1, further comprising a base, the base supporting and connected to the outer shell.

9. The ice pop maker of claim 8, further comprising springs positioned between the base and the outer shell, the outer shell and inner sleeve movable towards said base within a range of motion.

10. The ice pop maker of claim 9, wherein the base further comprises upward projecting members axially aligned with the at least one aperture through the inner sleeve.

11. The ice pop maker of claim 10, wherein the outer shell and inner sleeve are movable towards the base within a range of downward motion, the upward projecting members contacting the mold insert via the at least one aperture through the inner sleeve and thereby limiting the downward motion of the mold insert towards the base.

12. A method of using an ice pop maker, the method comprising the steps of:
storing an ice pop maker in a freezer for a period of time;
removing the ice pop maker from the freezer;
filling a mold insert with an edible product;
inserting the mold insert into the ice pop maker;
placing a stick into the mold insert;
following the preceding steps, freezing the contents of the mold insert;
removing the mold insert with the frozen edible product from the ice pop maker;
exposing the mold insert to at least one of the following conditions: a fluid bath, a fluid stream, and ambient air conditions; and
removing the ice pop from the mold insert by hand by retracting the stick from the mold insert.

13. The method of claim 12, wherein the step of removing the mold insert further comprises the steps of pushing down on the ice pop maker and releasing the mold insert from the ice pop maker.

14. The method of claim 12, further comprising the step of cleaning the mold insert while it is removed from the ice pop maker.

15. The method of claim 12, wherein the step of removing the mold insert further comprises the steps of supporting the ice pop maker on a base, positioning springs between the base and the ice pop maker, and moving the ice pop maker relative to the mold insert.

16. The method of claim 15, wherein the step of moving the ice pop maker relative to the mold insert includes the step of biasing the springs positioned between the base and the ice pop maker.
